(19) United States
(12) Patent Application Publication
(10) Pub. No.: US 2026/0235301 A1
(43) Pub. Date: Aug. 13, 2026

(54) COOKING VENTILATION SYSTEM

(71) Applicant: Haier US Appliance Solutions, Inc., Wilmington, DE (US)

(72) Inventors: Bagawathkumar Chellappan, Prospect, KY (US); Gopi Krishna Chowdary Vulava, Louisville, KY (US); Sachin Nagane, Louisville, KY (US); Todd Charles Hansen, Shelbyville, KY (US)

(21) Appl. No.: 19/052,816

(22) Filed: Feb. 13, 2025

(51) Int. Cl. F24C 15/20; H05B 6/64

(52) U.S. Cl. CPC F24C 15/2071; F24C 15/2021; F24C 15/2035; H05B 6/64

(57) ABSTRACT

A cooking appliance system includes an external enclosure that defines a first vent inlet, a second vent inlet, and a vent outlet. The cooking appliance system includes a plurality of lateral fans fluidly coupled with the first vent inlet. The cooking appliance system includes a main fan fluidly coupled with the second vent inlet. The cooking appliance system includes a first heating element. The plurality of lateral fans directs air from the first heating element into the first vent inlet. The cooking appliance system includes a second heating element. The main fan directs air from the second heating element into the second vent inlet.

### FIELD OF THE INVENTION

The present subject matter relates generally to systems for aiding cooking operations, and more particularly to methods for ventilating cooking systems.

### BACKGROUND OF THE INVENTION

Cooktop or range appliances generally include heating elements for heating cooking utensils, such as pots, pans, and griddles. A variety of configurations can be used for the heating elements located on the cooking surface of the cooktop. The number of heating elements or positions available for heating on the range appliance can include, for example, four, six, or more depending upon the intended application and preferences of the buyer. These heating elements can vary in size, location, and capability across the appliance. Further, each heating element, in operation, can allow food items to produce steam, odors, smoke, etc.

Some range appliances may include an over-the-range (OTR) ventilation system that is configured to capture and redirect air and cooking fumes from the cooktop. These systems often do not handle all vapors produced by cooking food. Further, conventional OTR systems can allow vapors that pass in front of the system to circulate throughout the kitchen without being captured by the OTR ventilation system.

As a result, it would be useful to provide a cooking appliance system that captures more cooking related air. Particularly, a cooking appliance system that manages multiple ventilation operations with one or more heating elements would be beneficial.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooking appliance system includes an external enclosure that defines a first vent inlet, a second vent inlet, and a vent outlet. The cooking appliance system includes a plurality of lateral fans fluidly coupled with the first vent inlet. The cooking appliance system includes a main fan fluidly coupled with the second vent inlet. The cooking appliance system includes a first heating element. The plurality of lateral fans directs air from the first heating element into the first vent inlet. The cooking appliance system includes a second heating element. The main fan directs air from the second heating element into the second vent inlet.

In another exemplary aspect of the present disclosure, an over-range ventilation system includes an external enclosure that includes a first lateral panel that defines a first vent inlet. The external enclosure includes a bottom panel that defines a second vent inlet. The over-range ventilation system includes a plurality of lateral fans disposed within the external enclosure. A first fan of the plurality of fans is fluidly coupled with the first vent inlet. The over-range ventilation system includes a main fan disposed within the external enclosure. The main fan is fluidly coupled with the second vent inlet. The over-range ventilation system also includes a controller communicatively coupled with the plurality of lateral fans and the main fan.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front perspective view of a system according to example embodiments of the present disclosure.

FIG. 2 provides a side schematic view of the example system of FIG. 1.

FIG. 3 provides a side perspective view of a first lateral enclosure of an over-range ventilation system of the example system of FIG. 1.

FIG. 4 provides a top perspective of the example system of FIG. 1 having a main fan.

FIG. 5 provides a perspective view of the example system of FIG. 1 in operation.

FIG. 6 provides a bottom view of the ventilation system of FIG. 3.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As shown cooking appliance system 100 defines a vertical direction V, a lateral direction L, and a transverse direction T, for example, at a microwave 106. The vertical, lateral, and transverse directions are mutually perpendicular and form an orthogonal direction system. As shown, cooking appliance system 100 extends along the vertical direction V between an over-range ventilation system 102 and a lower appliance that includes a range 104; along the lateral direction L between a left side and a right side; and along the traverse direction T between a front side and a rear side. For example, the over-range ventilation system 102 includes an external enclosure 108 that includes a first lateral panel 110 and a second lateral panel 112 that may extend along a lateral-vertical plane at a front face of the microwave 106, as illustrated. The external enclosure 108 also includes a bottom panel 116 that may extend along a lateral-transverse plane, as illustrated. The external enclosure 108 includes back panel 120 that extends along the lateral-vertical plane, as illustrated. The external enclosure 108 further includes a top panel 118 that extends along the lateral-transverse plane, as illustrated. Moreover, although a generally rectangular shape is illustrated, any suitable shape or style may be adapted to form the structure of the external enclosure 108. The external enclosure 108 is described in greater detail below.

The cooking appliance system 100 includes the external enclosure 108 and the range 104. The range 104 may be positioned on top of an oven, as illustrated. The external enclosure 108 is generally spaced vertically above the range 104, such that smoke, odors, vapors, etc. that drift upward from the range 104 also drift toward the external enclosure 108. As will be understood by those skilled in the art, the cooking appliance system 100 is provided by way of example only, and the present subject matter may be used in any suitable cooking appliance, such as a double oven range appliance, stand-alone oven, wall-mounted oven, or a standalone cooktop (e.g., fitted integrally with a surface of a kitchen counter). Thus, the example embodiments illustrated in figures are not intended to limit the present subject matter to any particular cooking chamber or heating element configuration, except as otherwise indicated.

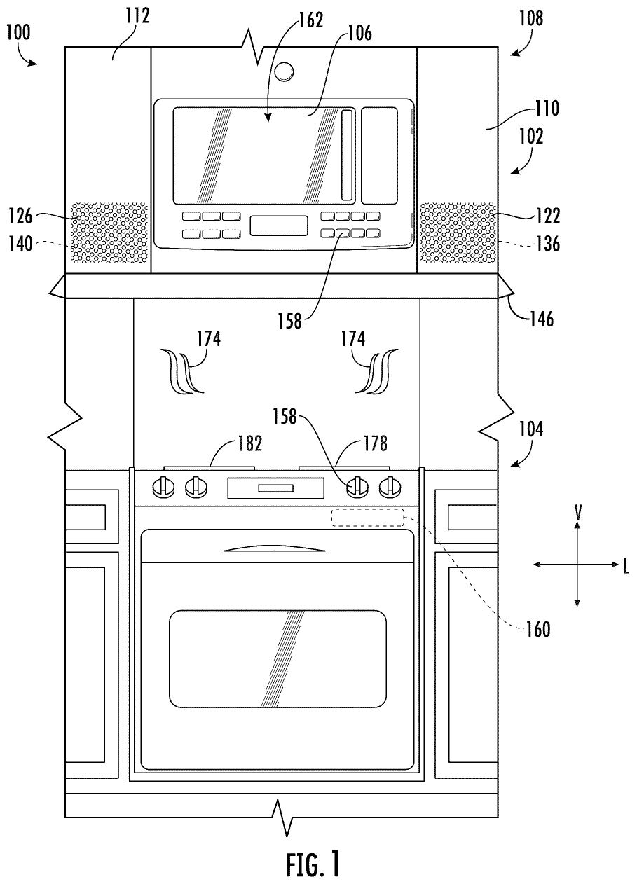

The range 104 may include a plurality of heating elements that includes a first heating element 178, a second heating element 180, a third heating element 182, a fourth heating element 184, and additional heating elements 186. The first heating element 178 and the third heating element 182 are illustrated on FIG. 1. The heating elements may be configured to heat cookware 176 such as a pot or a pan, for example. A food item positioned on or within the cookware 176 may release the odors, smoke, vapors, etc. during a cooking process. The heating elements are described in greater detail below. One or more heating elements (e.g., top broiling elements or bottom baking elements) may be enclosed within the oven. The heating elements 178, 180, 182, 184, and 186 may be provided as any suitable element for cooking a food item, such as an electric resistive heating element, a gas burner, microwave element, halogen element, etc.

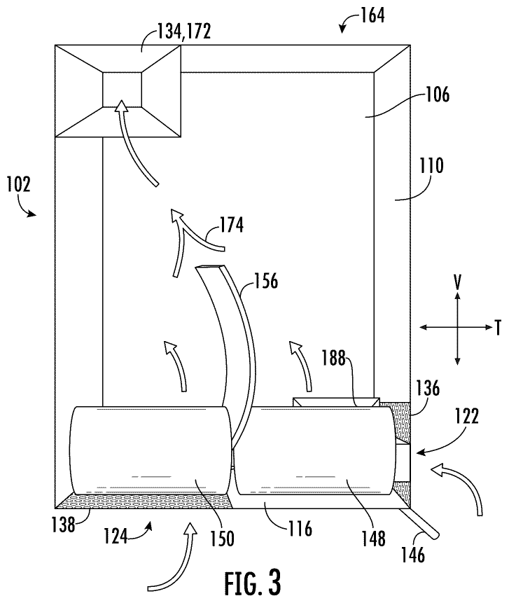

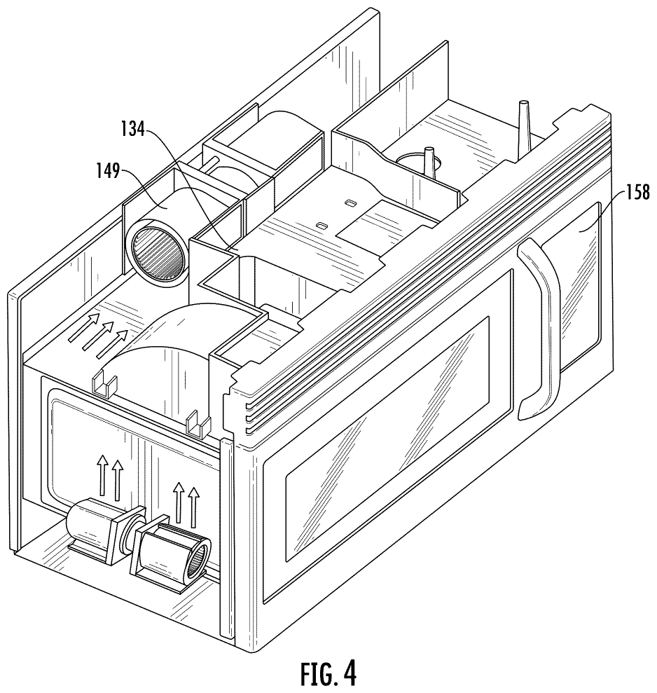

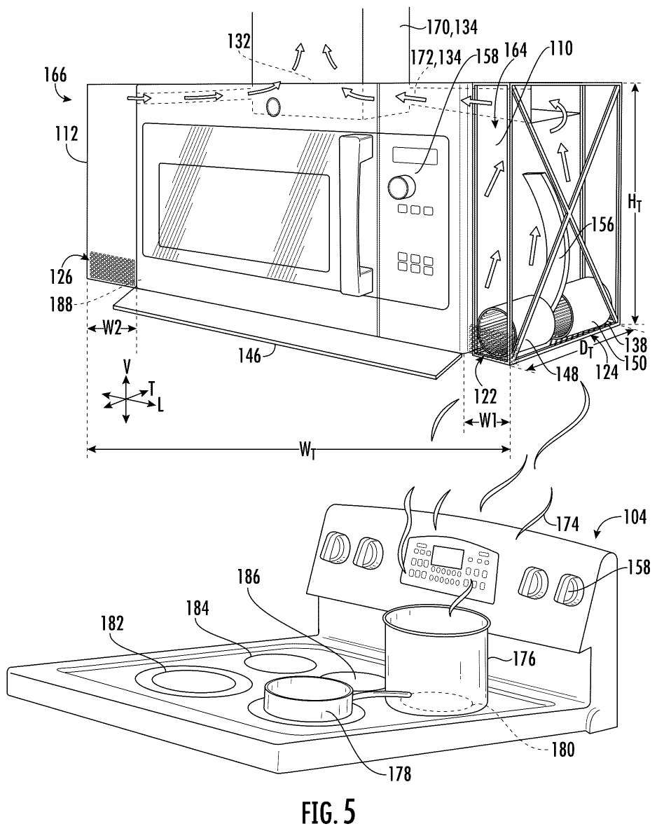

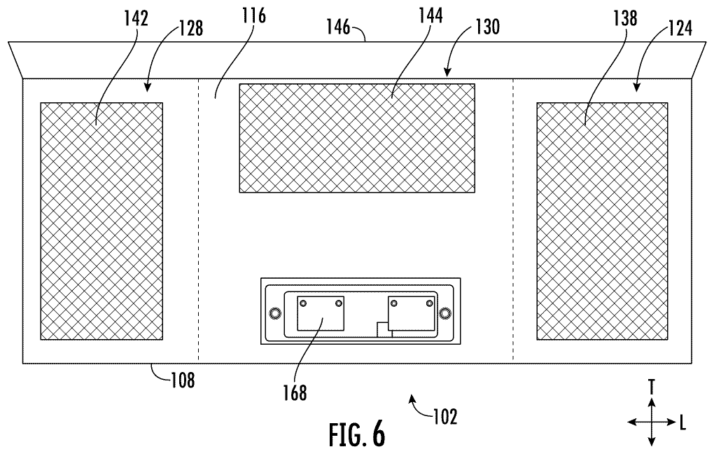

With reference to FIGS. 1 through 6, the cooking appliance system 100 includes the OTR ventilation system 102 or over-range ventilation system. The OTR ventilation system 102 includes a first vent inlet 122 defined by the external enclosure 108. More specifically, the first vent inlet 122 is defined by the first lateral panel 110. The first vent inlet 122 may be further defined by a grate or mesh pattern, as illustrated. For example, air 174 that is transversely in front of the first lateral panel 110 may be drawn into the first vent inlet 122. The OTR ventilation system 102 includes a main fan 149 and a plurality of lateral fans 147 including a first fan 148 disposed within the external enclosure 108. The main fan 149 may be fluidly coupled with at least one of the first vent inlet 122, the second vent inlet 124, the third vent inlet 126, the fourth vent inlet 128, and the front vent inlet 130. The first fan 148 of the plurality of lateral fans 149 may be positioned transversely behind the first lateral panel 110. The first fan 148 may even abut the first lateral panel 110. The first fan 148 is fluidly coupled with the first vent inlet 122. For example, air 174, odors, smoke, etc. that are transversely in front of the external enclosure 108 may be directed through the first vent inlet 122 via the first fan 148. Additionally, or alternatively, the first fan 148 may direct air 174 from one or more of the heating elements 178, 180, 182, 184, or 186 through the first vent inlet 122.

The OTR ventilation system 102 includes a third fan 152 disposed within the external enclosure 108. The third fan 152 may be positioned transversely behind the first fan 148. The third fan 152 may even abut the bottom panel 116. The external enclosure 108 defines a second vent inlet 124. More specifically, the bottom panel 116 may define the second vent inlet 124. The third fan 152 is fluidly coupled with the second vent inlet 124. For example, air 174, odors, smoke, etc. that are vertically beneath the external enclosure 108 may be directed through the second vent inlet 124 via the third fan 152. Additionally, or alternatively, the third fan 152 may direct air 174 from one or more of the heating elements 178, 180, 182, 184, or 186 through the second vent inlet 124.

The first fan 122 and the second fan 124 may be centrifugal fans with blades or impellers that spin to draw air 174 in and then push the air 174 out. The first fan 122 and the second fan 124 may create static pressure to move the air 174. Additionally, or alternatively, the first fan 148 and the third fan 152 may be axial fans with blades that rotate around a central axis to move the air 174 in a similar direction of the blades.

The cooking appliance system 100 may include a microwave 106 at least partially disposed within the external enclosure 108. The microwave 106 defines a cooking cavity 162 that may be used, for example, to heat the food item. Odors, and the like, produced within the cooking cavity 162 may ultimately be moved by at least one of the first fan 148 and the third fan 152. For example, the microwave 106 that is open may release odors, and the like, that are directed through the first vent inlet 122 by the first fan 148. The microwave 106 may be positioned between the first lateral panel 110 and the second lateral panel 112. Additionally, or alternatively, the first fan 148 and the third fan 152 may be positioned laterally adjacent to the microwave 106. The microwave 106, the first lateral panel 110, the back panel 120, the bottom panel 116, and the external enclosure 108 may define a first lateral enclosure 164. The first fan 148 and the third fan 152 may be disposed within the first lateral enclosure 164.

The external enclosure 108 has a total width W_{T}. The first lateral panel 110 has a first width W1. The second lateral panel 112 has a second width W2 that may be about equal to the first width W1. The total width W_{T} may be about equal to ten times the first width W1. Additionally, or alternatively the total width W_{T} may be about equal to ten times the second width W2. The microwave 106 may have a width that is about equal to the total width W_{T} less the first width W1 and less the second width W2. For example, the total width W_{T} may be about thirty inches, the first width W1 may be about three inches, the second width W2 may be about three inches, and a width of the microwave 106 may be about twenty-four inches. Additionally, or alternatively, the first width W1 may be about three inches, the second width W2 about three inches, the total width W_{T} about forty-two inches, and the microwave 106 may have a width of about thirty-six inches. The external enclosure 108 has a total depth D_{T}. The total depth D_{T} is greater than first width W1. The total depth D_{T} is also greater than second width W2. Furthermore, the external enclosure 108 also has a total height H_{T}. The total height H_{T} may be about equal to the total depth D_{T}.

The OTR ventilation system 102 includes a vent outlet 132 defined by the external enclosure 108. More specifically, the vent outlet 132 may be defined by the top panel 118. The vent outlet 132 is fluidly coupled with the first fan 148 and the third fan 152, such that air 174 moved by the first fan 148 and the third fan 152 is directed through at least the first vent inlet 122 and the second vent inlet 124, respectively, through the first lateral enclosure 164, and out the vent outlet 132.

Additionally, or alternatively, the OTR ventilation system 102 may include a duct 134 coupled with the external enclosure 108. The duct 134 may define the vent outlet 132 to move the air 174 away from the cooking appliance system 100. Additionally, or alternatively, the duct 134 may include an internal duct portion 172 that is disposed within the external enclosure 108. Additionally, or alternatively, the duct 134 may include an external duct portion 170 that extends away from the external enclosure 108. Therefore, the first fan 148 and the third fan 152 may direct the air 174 through the duct 134. Additionally, or alternatively, the first fan 148 and the third fan 152 may direct the air 174 through the internal duct portion 172. For example, air 174 may be moved from the first heating element 178, through the first vent inlet 122, through the first lateral enclosure 164, through the internal duct portion 172 of the duct 134, through the external duct portion 170, and through the vent outlet 132.

The OTR ventilation system 102 of the cooking appliance system 100 may further define a second lateral enclosure 166. More specifically, the second lateral enclosure 166 may be defined by the second lateral panel 112, the back panel 120, the microwave 106, the bottom panel 116, the top panel 118, and the external enclosure 108. The second lateral panel 112 may define a third vent inlet 126. The third vent inlet 126 may be similar to the first vent inlet 122. For example, the third vent inlet 126 may be further defined by a grate or mesh pattern, as illustrated. The external enclosure 108 may further define a fourth vent inlet 128. More specifically, the bottom panel 116 may define the fourth vent inlet 128. The fourth vent inlet 128 may be similar to the second vent inlet 124.

The OTR ventilation system 102 may include a second fan (not shown, but reflective of the first fan 148) disposed within the external enclosure 108. The second fan may be reflective of the first fan 148. The second fan may be positioned transversely behind the second lateral panel 112. The second fan may even abut the second lateral panel 112. The second fan is fluidly coupled with the third vent inlet 126. For example, air 174, odors, smoke, etc. that are transversely in front of the external enclosure 108 may be directed through the third vent inlet 126 via the second fan. Additionally, or alternatively, the second fan may direct air 174 from one or more of the heating elements 178, 180, 182, 184, or 186 through the third vent inlet 126.

The OTR ventilation system 102 may include a fourth fan (not shown) disposed within the external enclosure 108. The fourth fan may be reflective of the third fan 152. The fourth fan may be positioned transversely behind the second fan. The fourth fan may even abut the bottom panel 116. The fourth fan is fluidly coupled with the fourth vent inlet 128. For example, air 174, odors, smoke, etc. that are vertically beneath the external enclosure 108 may be directed through the fourth vent inlet 128 via the fourth fan. Additionally, or alternatively, the fourth fan may direct air 174 from one or more of the heating elements 178, 180, 182, 184, or 186 through the fourth vent inlet 128.

The OTR ventilation system 102 may include a baffle 156 disposed within each of the first lateral enclosure 164 and the second lateral enclosure 166. The baffle 156 may be generally arcuate to allow for smooth movement of the air 174. The baffle 156 may direct air 174 from the first fan 148 and the third fan 152 toward the duct 134 in the first lateral enclosure 164. The baffle 156 may direct air 174 from the second fan and the fourth fan toward the duct 134 in the second lateral enclosure 166. In other words, the OTR ventilation system 102 may be mirrored across a lateral center such that the first lateral enclosure 164 is similar to the second lateral enclosure 166.

The OTR ventilation system 102 may further define a front vent inlet 130. More specifically, the bottom panel 116 of the external enclosure 108 may define the front vent inlet 130 proximal to the front of the microwave 106. The OTR ventilation system 102 may include a front filter 144 coupled with the front vent inlet 130. The external enclosure 108 may further define a front passage 188 fluidly coupled with the front vent inlet 130 and at least one of the first fan 148, the third fan 152, the second fan, and the fourth fan. Therefore, one or more of the fans may move air 174 through the front vent inlet 130.

The OTR ventilation system 102 may be configured to move about 300 cubic feet of air 174 per minute. Additionally, or alternatively, each of the first fan 148, the third fan 152, the second fan, or the fourth fan may be configured to move about 300 cubic feet of air 174 per minute.

The cooking appliance system 100 may include a hood panel 146 coupled with the external enclosure 108 and extending away therefrom. For example, the hood panel 146 may be angled to extend transversely from the external enclosure 108 vertically downward. The hood panel 146 may be vertically above the range 104 such that steam, odors, air 174, and the like, are directed toward the bottom panel 116 of the external enclosure 108. For example, air 174 may contact the hood panel 146 and drift toward the second vent inlet 124 or the fourth vent inlet 128 to be moved therethrough by the third fan 152 and the fourth fan, respectively. Air 174 that happens to drift past, or above, the hood panel 146 may be directed through the first vent inlet 122 or the third vent inlet 126 by the first fan 148 and the second fan, respectively.

The OTR ventilation system 102 may include a plurality of filters. For example, the OTR ventilation system 102 may include a first filter 136 coupled with the first vent inlet 122, a second filter 138 coupled with the second vent inlet 124, a third filter 140 coupled with the third vent inlet 126, and a fourth filter 142 coupled with the fourth vent inlet 128. The respective plurality of filters 136, 138, 140, and 142 may allow the OTR ventilation system 102 to move filtered air 174 into the external enclosure 108. Additionally, or alternatively, the OTR ventilation system 102 may recirculate air 174 back into the surrounding area around the cooking appliance system 100; the respective plurality of filters 136, 138, 140, and 142 may allow the recirculated air 174 to be filtered before leaving the external enclosure 108. The filters 136, 138, 140, and 142 may be grease filters made of aluminum or stainless steel mesh. The filters 136, 138, 140, and 142 may capture grease particles from the air 174 to prevent buildup inside the external enclosure 108 and the duct 134. Additionally, or alternatively, the filters 136, 138, 140, and 142 may be charcoal (or carbon) filter made with activated charcoal or carbon to absorb odors and smoke. Additionally, or alternatively, any other suitable filter used to filter particles from air may be used.

As illustrated, the cooking appliance system may include a user input device 158. Although shown at the front portion of the microwave 106 and the oven, another suitable location or structure (e.g., a backsplash) for supporting user input devices 158 may be provided in alternative embodiments. In some embodiments, user input devices 158 include input components or controls, such as one or more of a variety of electrical, mechanical, or electro-mechanical input devices. The user input devices 158 may include, for example, rotary dials, knobs, push buttons, and touch pads. A controller 160 is in communication with user input device 158 through which a user may select various operational features and modes and monitor progress of cooking appliance system 100. In additional or alternative embodiments, the cooking appliance system may include a display component, such as a digital or analog display in communication with a controller 160 and configured to provide operational feedback to a user. In certain embodiments, user input device 158 represents a general purpose I/O (“GPIO”) device or functional block.

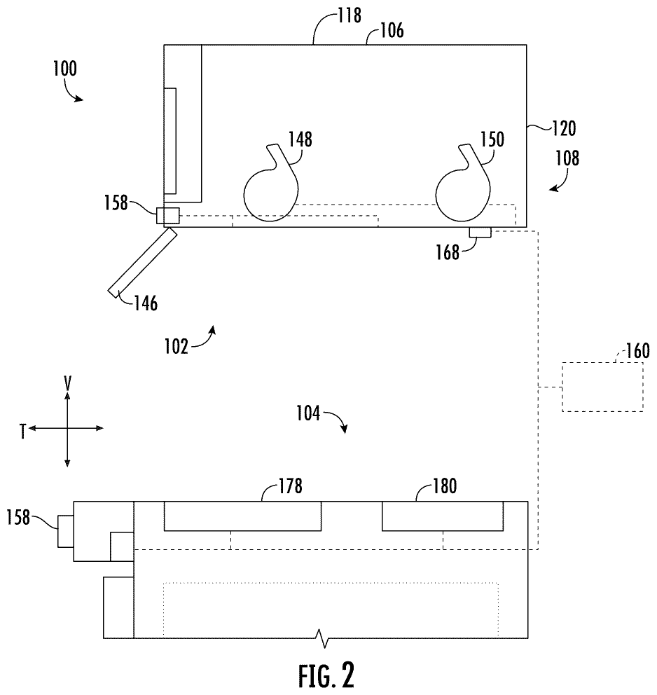

As shown, controller 160 is communicatively coupled (i.e., in operative communication) with the user input device 158. The controller 160 is also communicatively coupled with various operational components of the cooking appliance system 100 as well, including the heating elements (e.g., 178, 180, 182, 184, and 186), sensors, etc. Input/output (“I/O”) signals may be routed between controller 160 and the various operational components of cooking appliance system 100. Thus, controller 160 can selectively activate and operate these various components. Various components of cooking appliance system 100 are communicatively coupled with controller 160 via one or more communication lines such as, for example, conductive signal lines, shared communication busses, or wireless communications bands, as illustrated in FIG. 2.

In some embodiments, the controller 160 includes one or more memory devices and one or more processors. The processors can be any combination of general or special purpose processors, CPUs, or the like that can execute programming instructions or control code associated with operation of cooking appliance system 100. The memory devices (i.e., memory) may represent random access memory such as DRAM or read only memory such as ROM or FLASH. In one embodiment, the processor executes programming instructions stored in memory. The memory may be a separate component from the processor or may be included onboard within the processor. Alternatively, controller 160 may be constructed without using a processor, for example, using a combination of discrete analog or digital logic circuitry (such as switches, amplifiers, integrators, comparators, flip-flops, AND gates, and the like) to perform control functionality instead of relying upon software.

In certain embodiments, controller 160 includes a network interface such that controller 160 can connect to and communicate over one or more networks (e.g., the Internet) with one or more network nodes. Controller 160 can also include one or more transmitting, receiving, or transceiving components for transmitting/receiving communications with other devices communicatively coupled with cooking appliance system 100. Additionally, or alternatively, one or more transmitting, receiving, or transceiving components can be located off board controller 160. Generally, controller 160 may be positioned in any suitable location throughout cooking appliance system 100. For example, controller 160 may be located proximate the user input device 158 toward the front portion of cooking appliance system 100. Additionally, or alternatively, one or more transmitting, receiving, or transceiving components can be located off board such that the controller 160 is remote (e.g., a phone, tablet, personal computer, etc.).

The network can be any suitable type of network, such as a local area network (e.g., intranet), wide area network (e.g., internet), low power wireless networks [e.g., Bluetooth Low Energy (BLE)], or some combination thereof and can include any number of wired or wireless links. In general, communication over network 502 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL).

The controller 160 is also communicatively coupled with the OTR ventilation system 102. More specifically, the controller 160 is communicatively coupled with the main fan 149, and the plurality of lateral fans 147 including the first fan 148, the third fan 152, the second fan, and the fourth fan. The controller 160 may activate one fan at a time in response to receiving an activation signal from the user input device 158. Additionally, or alternatively, the controller 160 may activate a combination of one or more fans chosen from the main fan 149, the first fan 148, the third fan 152, the second fan, and the fourth fan in response to receiving an activation signal from the user input device 158. Additionally, or alternatively, the controller 160 may activate a fan chosen from the main fan 149, the first fan 148, the third fan 152, the second fan, and the fourth fan based on a heating element being active chosen from the first heating element 178, a second heating element 180, a third heating element 182, a fourth heating element 184, and additional heating elements 186. Additionally, or alternatively, the controller 160 may activate a fan that is closest to the heating element that is active. For example, the first heating element 178 may be closest to the first fan 148 among the fans; therefore, the controller 160 may activate the first fan 148 in response to the first heating element 178 being active. Additionally, or alternatively, the controller 160 may activate a fan chosen from the main fan 149, the first fan 148, the third fan 152, the second fan, and the fourth fan in response to receiving an activation signal from the user input device 158 and in response to at least one heating element being activated.

In optional embodiments, a lighting assembly 168 is provided above the range 104 (e.g., along the vertical direction V). For instance, lighting assembly 168 may be mounted to the external enclosure 108 (e.g., mounted on the bottom panel 116). Generally, lighting assembly 168 includes one or more selectable light sources directed toward the range 104. In other words, lighting assembly 168 is oriented to project a light to the range 104 and illuminate at least a portion of the range 104. The light sources may include any suitable light-emitting elements, such as one or more light emitting diode (LED), incandescent bulb, fluorescent bulb, halogen bulb, etc.

It should be understood that the system may establish or store any suitable number of cooktop-use profiles. For instance, when the cooktop appliance contains four heating elements, the system may separately store four cooktop-use profiles which may be presented interchangeably on the image monitor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooking appliance system comprising:
an external enclosure comprising:
a first lateral panel defining a first vent inlet;
a bottom panel defining a second vent inlet; and
a top panel defining a vent outlet;
a plurality of lateral fans disposed within the external enclosure, a first fan of the plurality of lateral fans being fluidly coupled with the first vent inlet;
a main fan disposed within the external enclosure, the second fan fluidly coupled with the second vent inlet and the vent outlet;
a first heating element vertically beneath the external enclosure, wherein the first fan directs air from the first heating element into the first vent inlet; and
a second heating element vertically beneath the external enclosure, wherein the second fan directs air from the second heating element into the second vent inlet.

2. The cooking appliance system of claim 1 further including a microwave disposed within the external enclosure, the microwave defining a cooking cavity, wherein the at least one lateral fan is laterally adjacent to the microwave.

3. The cooking appliance system of claim 2, wherein the external enclosure further includes a second lateral panel that defines a third vent inlet, and wherein the bottom panel further defines a fourth vent inlet fluidly coupled with the main fan.

4. The cooking appliance system of claim 3, wherein the first lateral panel has a first width, the second lateral panel has a second width, and wherein a total width of the external enclosure is about ten times greater than at least one of the first width or the second width.

5. The cooking appliance system of claim 3, further comprising:
a second fan of the plurality of lateral fans being disposed within the external enclosure, wherein the second fan is fluidly coupled with the third vent inlet, and wherein the second fan is spaced from a first fan of the plurality of lateral fans by the microwave.

6. The cooking appliance system of claim 5, wherein the bottom panel further defines a front vent inlet fluidly coupled with at least one of the first fan, the second fan, or the main fan.

7. The cooking appliance system of claim 1, further comprising a hood panel extending from the external enclosure, wherein the hood panel directs air toward the bottom panel.

8. The cooking appliance system of claim 1 further comprising a duct disposed within the external enclosure, wherein the duct further defines the vent outlet, and wherein the duct is fluidly coupled with the first fan and the second fan.

9. The cooking appliance system of claim 1, wherein the plurality of lateral fans and the main fan operate in tandem.

10. The cooking appliance system of claim 1 further comprising a controller communicatively coupled with the plurality of lateral fans, the main fan, the first heating element, and the second heating element, wherein the controller is configured to activate the plurality of lateral fans in response to the first heating element being activated, and wherein the controller is further configured to activate the main fan in response to the second heating element being activated.

11. The cooking appliance system of claim 10, further comprising a user input device, wherein the controller is further configured to activate the plurality of lateral fans in response to an input from the user input device, and wherein the controller is further configured to activate the main fan in response to the input from the user input device.

12. The cooking appliance system of claim 1, further comprising a plurality of filters respectively coupled with the first vent inlet and the second vent inlet.

13. An over-range ventilation system comprising:
an external enclosure comprising:
a first lateral panel defining a first vent inlet; and
a bottom panel defining a second vent inlet;
a plurality of lateral fans disposed within the external enclosure, a first fan of the plurality of lateral fans fluidly coupled with the first vent inlet;
a main fan disposed within the external enclosure, the main fan fluidly coupled with the second vent inlet; and
a controller communicatively coupled with the plurality of lateral fans and the main fan.

14. The over-range ventilation system of claim 13 further including a microwave disposed within the external enclosure, the microwave defining a cooking cavity, wherein the plurality of lateral fans are laterally adjacent to the microwave.

15. The over-range ventilation system of claim 14, wherein the external enclosure further includes a second lateral panel that defines a third vent inlet, and wherein the bottom panel further defines a fourth vent inlet fluidly coupled with the main fan.

16. The over-range ventilation system of claim 15, wherein the first lateral panel has a first width, the second lateral panel has a second width, and wherein the first width and the second width are each less than a total depth of the external enclosure.

17. The over-range ventilation system of claim 15 further comprising:
a second fan of the plurality of lateral fans disposed within the external enclosure, wherein the second fan is fluidly coupled with the third vent inlet, and wherein the second fan is spaced from the first fan by the microwave.

18. The over-range ventilation system of claim 13, wherein the plurality of lateral fans and the main fan operate in tandem.

19. The over-range ventilation system of claim 1 further comprising a duct disposed within the external enclosure, wherein the duct is fluidly coupled with the first fan and the main fan.

20. The over-range ventilation system of claim 1 further comprising:
a first filter covering the first inlet; and
a second filter covering the second inlet.
